(19) United States
(12) Patent Application Publication
(10) Pub. No.: US 2008/0301343 A1
(43) Pub. Date: Dec. 4, 2008

(54) DEVICE FOR CONTROLLING COMMUNICATION BETWEEN A MODULE AND A TRANSMISSION BUS

(75) Inventors: Jean-Jacques ADRAGNA, Antibes (FR); Alain Meurlay, Nice (FR); Serge Rugo, La Roquette Sur Siagne (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Schneider Electric Industries SAS, Rueil-Malmaison (FR)

(21) Appl. No.: 12/123,044

(22) Filed: May 19, 2008

(30) Foreign Application Priority Data
May 29, 2007 (FR) 07 55297

(51) Int. Cl. G06F 13/00

(52) U.S. Cl. 710/107

(57) ABSTRACT

The invention relates to a device for controlling communication between a module (10) and a transmission bus (22), comprising a communication control unit (23) disposed between the transmission bus (22) and a connection element (21) intended to connect the module (10) to the transmission bus (22), the said unit (23) comprising a control input (25) and being able to place the connection element (21) in communication with the transmission bus (22) by applying a validation signal to the control input (25), the device comprising means (12) present in the module (10) for generating the said validation signal. Application to programmable controllers.

The present invention pertains to a device for controlling communication between a module and a transmission bus. The invention finds a particularly advantageous application in the field of programmable controllers.

A programmable controller or PLC (“Programmable Logical Controller”) is an automatic control facility capable of driving, controlling and/or monitoring one or more processes, in particular in the field of industrial control rigs, construction or electrical distribution.

Of generally modular design, a PLC programmable controller is composed of various modules which intercommunicate through a transmission bus, generally called a “backplane” bus. The modules are fixed mechanically in a rack, which comprises a printed circuit which also supports the backplane bus as well as the connection elements intended to cooperate with connectors generally present on the rear part of the modules so as to effect the necessary link between the modules and the bus. The number of modules depends of course on the size and the type of process to be automated.

Typically, a programmable controller can comprise:
a power supply module providing the various voltages to the other modules through the backplane bus.
a central unit module UC which comprises embedded software (“firmware”) integrating a real-time operating system OS, and an application program, or user program, containing the instructions to be executed by the embedded software to perform the desired control operations. The UC module also generally comprises a connection on the front face to programming tools of personal computer PC type.
input/output I/O modules of various types as a function of the process to be controlled, such as digital I/Os or analogue TORs for counting, etc. These I/O modules are linked to sensors and actuators participating in the automated management of the process.
one or more modules for communicating with communication networks (Ethernet, CAN, etc.) or man-machine interfaces (screen, keyboard, etc.).

By way of example, an input/output module can comprise between 1 to 32 I/O pathways, a PLC controller that may be capable, depending on the model, of managing several hundred I/O pathways. If required, several racks are therefore connected together in one and the same PLC.

Thus, as a function of the application and the process to be automated, a PLC controller may comprise a large number of modules. During normal operation, if one of the modules drops out of service, one wishes to be able to replace it without interfering with the other modules of the PLC. It is therefore necessary to be able to extract the failed module while it is powered up, then insert a replacement module, without disturbing the remainder of the configuration of the controller and the running of the program. This is what is called the “hot swap” function.

The same situation arises when the user customer decides, as a function of his application or of his process, to remove a module from a location of a rack and/or to add one to an empty location.

To solve the difficulties related to the hot swapping of modules, a first solution has been proposed consisting in carrying out, as a function of the signals applied, a sequencing over time of the electrical connection between the backplane connection element and the connector present on the module, in such a way for example as to ensure the following order of connection when inserting a module: ground, positive supply voltage, useful signals, etc. For this purpose, the known solution proposed envisages giving different lengths, in accordance with the order of connection desired, to the various pins of the backplane connection element or of the connector of the module.

The advantage of this solution is of being certain of the sequencing of the signals when inserting and extracting the module of the backplane. For example, the ground signal always remains connected for a longer time than the positive supply voltage, therefore the corresponding pin will be longer.

On the other hand, this known system exhibits several drawbacks, in particular mechanical wear and especially its cost since it uses non-standard specific connectors. Moreover, it is necessary to provide for a significant length of the pins so as to create length offsets sufficient to obtain time intervals necessary for the insertion/extraction sequences. These significant lengths for the pins of the connectors may turn out to be incompatible with the overall proportions of the programmable controller.

A second existing solution consists in inserting the connector of the module into the backplane connection element by rotation about an axis, thereby making it possible to ensure that the pins close to the rotation axis are connected before those furthest therefrom, when inserting a module following a rotational movement about the axis.

The advantage of this system is identical to that previously described. Its main drawback is that it imposes additional specifications on connectors not initially envisaged for this function. Moreover, tolerancing is difficult to carry out for small products since the connectors will comprise very closely spaced pins, and it may therefore be difficult to obtain reproducible behaviour under any circumstance.

So, an aim of the invention is to propose a device which would allow the hot insertion of a module onto the transmission bus, without disturbing the operation of the other modules already present or disturbing the communication signals circulating on the bus, and while avoiding the mechanical constraints related to the realization of the pins and connectors as in the known systems described above.

This aim is achieved, in accordance with the invention, by virtue of a device for controlling communication between a module and a transmission bus, characterized in that the device comprises:
a communication control unit disposed between an element for connecting the module to the transmission bus and the transmission bus, the said unit comprising a control input and being able to place the connection element in communication with the transmission bus by applying a validation signal to the control input,
in the module, means for generating the validation signal.

Thus, the device in accordance with the invention guarantees that, when inserting the module into the backplane connection element, communication with the transmission bus will be established by the communication control unit if, and only if, the latter has received on the control input a validation signal indicating that the module is ready to communicate under optimal conditions with the backplane communication bus. Startup of the inserted module is therefore completely deterministic.

It is understood from the definition which has just been given of the invention that the latter is not limited solely to the field of programmable controllers and that it extends to any modular system based on a transmission bus of the “backplane” type.

By lifting the mechanical constraints of the known systems, the invention makes it possible to use standard connectors with the advantage in terms of cost that this represents. Moreover, insertion under power is guaranteed even on small products for which the requirement for low cost made it impossible to produce by traditional mechanical dimensioning and tolerancing.

Contrary to the previous mechanical systems capable of producing intermittent and uncertain communication when the module is poorly inserted into the connection element, the device of the invention prohibits any communication so long as the validation signal is not received on the control input.

According to one characteristic, the said means for generating the validation signal comprise a logic component which receives as input at least one input signal characteristic of a state of the module and which delivers an output, the said output generating the validation signal when the said input signal is representative of an operating state of the module compatible with the placing of the module in communication with the transmission bus.

As will be seen in detail further on, the input signal can be generated on the basis of the presence of the voltages of the module as well as various information on the state and/or the proper operation of the module.

The invention also envisages the possibility, when extracting the module under power, of guaranteeing safe withdrawal of the module though the latter may still be energized because the power supply pins are still connected or because the module comprises its own auxiliary energy source (battery or capacitor).

With this aim, according to the invention, the said communication control unit is able to prevent communication between the said connection element and the transmission bus by applying a passivation signal to the control input of the communication control unit.

Advantageously, when the passivation signal is applied to the control input, this creates a high impedance between the inputs and the outputs of the communication control unit, that is to say between the signals of the transmission bus that are present on the backplane circuit and the signals of the transmission bus that are present on the connection element of the corresponding module. In this way, the backplane bus is not affected by any spurious signals while extracting the module and when the module is absent.

The passivation signal can be produced according to two different modes of generation.

According to a first mode, the output of the logic component generates the passivation signal when one of its input signals is representative of an operating state of the module that is incompatible with the placing of the module in communication with the transmission bus. This mode of generation corresponds to a module which is not yet ready to communicate or that is no longer so following a defect that appeared during the operation of the module. The passivation signal is produced in this case by the module itself.

According to a second mode, the passivation signal is generated, when the module is disconnected from the connection element, by a passivation module disposed between the connection element and the control input. This mode of generation corresponds to the situation where the backplane connection element is not or is no longer connected to a module. The passivation signal is then produced by the backplane circuit passivation module.

In a practical manner, the invention envisages that the communication control unit is chosen from among the following means: three-state logic gates, electromechanical relays, static relays.

The invention also describes an automatic control facility comprising a transmission bus and a plurality of modules capable of connecting to the transmission bus and comprising at least one such communication control device.

According to the invention, the automatic control facility can also comprise a mechanical system for inserting and extracting the module by rotation about an axis. This system makes it possible in particular to sequence the order of disappearance of signals at the moment of the rotational movement performed while extracting the module. For example, the common point (0V) of the electrical power supply of the module can be applied at a point of the connection element situated in proximity to the said rotation axis, and the said control input is linked to a point of the connection element situated in proximity to an opposite end of the connection element from the said rotation axis.

This use combines the device in accordance with the invention and the rotational insertion/extraction system described above. This combination is indeed achievable even with small dimensions of the automatic control facility, since the device of the invention has made it possible to reduce the number of constrained pins and it is then easier to space them out, to obtain a sufficient offset.

The description which will follow in regard to the appended drawing, given by way of nonlimiting example, will clearly elucidate the gist of the invention and the way in which it may be carried out.

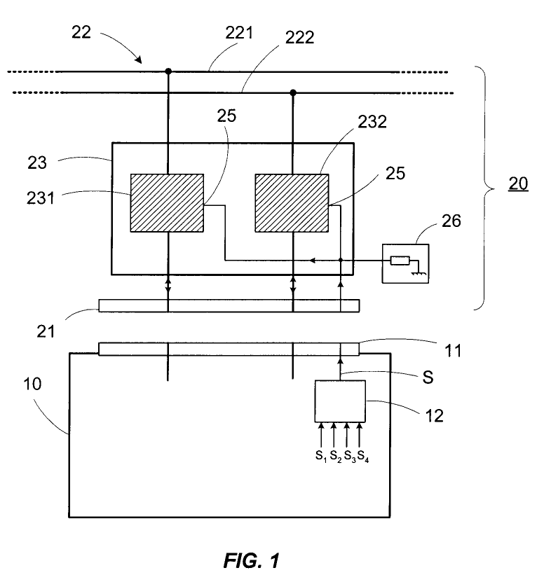

FIG. 1 is a diagram of a communication control device in accordance with the invention.

In FIG. 1 is represented a partial diagram of a modular automatic control facility of the programmable controller type, comprising a fixed part 20, such as a printed circuit called the backplane circuit 20, to which a module 10, such as an I/O module, can be connected or disconnected at will.

The backplane circuit 20 supports a transmission bus 22 serving the assembly of modules of the automatic control facility. The transmission bus 22 of FIG. 1 is for example a multipoint serial bus chiefly comprising two bidirectional transmission lines 221, 222, namely a line 221 for circulating the clock signals (“DEL”) of the bus and a line 222 for transmitting the data (“DATA”).

The backplane circuit 20 also comprises a plurality of connection elements 21, of backplane connector or pin type, each being intended to receive a corresponding suitable connector 11 of a module 10 when the latter is inserted into the rack of the automatic control facility. Once inserted, the electrical link between the connection element 21 and the connector 11 of the module 10 allows in particular the module 10 to be electrically energized and to be capable of communicating with other modules of the automatic control facility through the transmission bus 22. In FIG. 1, the module 10 is not completely inserted, since its connector 11 is disunited from the connection element 21 of the backplane circuit 20.

FIG. 1 also shows a device making it possible to control communication between the module 10 and the bus 22, that is to say to be able, in circumstances which will be explained further on, either to permit communication, or conversely to prevent it and isolate the module 10 from the bus 22, even when the module 10 is joined electrically to the connection element 21 of the backplane circuit 20.

As may be seen in FIG. 1, this communication control device comprises a communication control unit 23 which plays the role of communication logic barrier and which is composed of two bidirectional communication assemblies 231, 232 disposed on the backplane circuit 20, between the connection element 21 and the transmission lines 221, 222 respectively of the bus 22.

Each assembly 231, 232 comprises for example two logic gates with three states (also called a tri-state buffer) for unidirectional communication, disposed mutually head-to-tail so as to allow bidirectional communication between the module 10 and the lines 221, 222 of the bus 22.

The bidirectional communication assemblies 231, 232 could also be embodied as relays which would be closed in the presence of a validation signal, or open, therefore isolated, in the presence of a passivation signal, in place of the logic gates. In this case, one relay per transmission line is sufficient. Likewise, it would also be possible to use static relays embodied with MOSFET transistors since they provide very good isolation in the open position (resistance greater than 1 MΩ) and are highly conducting in the closed position.

The bidirectional communication assemblies 231, 232 comprise a control input 25 that operates as follows:
if the signal applied to this control input 25 is a validation signal of logic value 1, then the information passes through the assemblies 231, 232 and the module 10 is placed in communication with the bus 22 in a bidirectional manner.
Conversely, if the signal applied to the control input 25 is a passivation signal of logic value 0, that is to say inverse to the validation signal, then the outputs of the assemblies 231, 232 are in a high-impedance state, thereby isolating the bus 22 from the exterior and communication between the module 10 and the bus 22 is prevented.

Moreover, FIG. 1 also shows that the module 10 comprises a logic electronic component 12 able to generate an output S intended to be applied to the control inputs 25 in the guise of validation signal or passivation signal.

The output S is generated by the logic component 12 on the basis of one or more input signals S₁, S₂, S₃, S₄, etc. representative of an operating state of the module 10. The principle is that if the logic component 12 establishes that the values of this or these input signals are compatible with satisfactory placing of the module 10 in communication with the bus 22, the output S provides a validation signal of value 1 so as to activate the assemblies 231, 232. Conversely, if the module 10 is not ready to communicate because at least one of the input signals S₁, S₂, S₃, S₄, etc. indicates that the module 10 is not in a compatible state for satisfactory communication with the bus 22, the output S of the logic component 12 provides a passivation signal of value 0, thereby disabling the assemblies 231, 232.

Within the framework of very simple embodiments, a single input signal S₁ of the logic component 12 can be envisaged, in particular by being linked to the positive voltage (for example +5V) of the module via a resistor. In this case, the validation signal of value 1 indicates only that the module 10 is indeed energized.

In practice, it is however preferable that the output S of the logic component 12 results from a combination of a set of logic conditions established on a plurality of signals S₁, S₂, S₃, S₄, etc. characteristic of various states or modes of operation of the module 10, such as for example: the presence of power supply or supplies of the module, the absence of any defect on the module, the confirmation of proper execution of a test sequence or of initialization of the module, etc. This makes it possible to ensure that the module 10 is not only correctly energized but also in a fit state to operate correctly before it is placed in communication with the bus 22.

It is also possible to envisage a logic startup sequence to be executed before delivering the validation signal: detection of a sufficient voltage threshold in the module, then standby step so as to be sure of the completeness of insertion of the signals and the precharging of capacitors, then execution of a boot sequence inside the module, etc.

Equally, the logic component 12 can be integrated into a microprocessor of the module 10 or can constitute a particular component.

It should also be pointed out that certain signals of the transmission bus 22, other than the lines 221 and 222, can avoid the logic barrier represented by the communication control unit 23 and be directly connected between the bus 22 and the module 10.

It is also possible to see in FIG. 1 the presence on the backplane circuit 20 of a passivation module 26 intended to generate a passivation signal by return to ground through a resistor of low value when the module 10 is not connected to the backplane, and therefore when the output S is not linked to the unit 23. Thus, when the module 10 is not inserted into the rack, good isolation between the signals of the bus 22 on the backplane circuit 20 and the connection element 21 is advantageously permanently ensured.

It is obvious that, according to the type and characteristics of the bidirectional communication assemblies 231, 232 used, the values of the validation and passivation logic signals applied to the control input 25 could equally be inverted, namely 0 for the validation signal and 1 for the passivation signal. In this case, the generation of the output S would be modified accordingly and the resistor of the module 26 would be returned to the positive voltage of the circuit 20.

1. Device for controlling communication between a module (10) and a transmission bus (22), comprising a communication control unit (23) disposed between the transmission bus (22) and a connection element (21) intended to connect the module (10) to the transmission bus (22), the said unit (23) comprising a control input (25) and being able to place the connection element (21) in communication with the bus (22) by applying a validation signal to the control input (25), characterized in that the said device comprises means (12) present in the module (10) for generating the said validation signal, the said means comprising a logic component (12) which receives as input at least one input signal (S₁, S₂, S₃, S₄) characteristic of a state of the module (10) and which delivers an output (S), the said output (S) generating the said validation signal when the input signal (S₁, S₂, S₃, S₄) is representative of an operating state of the module compatible with the placing of the module (10) in communication with the transmission bus (22).

2. Device according to claim 1, characterized in that the communication control unit (23) is able to prevent communication between the connection element (21) and the transmission bus (22) by applying a passivation signal to the control input (25).

3. Device according to claim 2, characterized in that it comprises a passivation module (26) which is disposed between the connection element (21) and the control input (25), and which generates the said passivation signal when the module (10) is not connected to the connection element (21).

4. Device according to claim 2, characterized in that the communication control unit (23) exhibits a high input impedance for the transmission bus (22) when the said passivation signal is applied to the control input (25).

5. Device according to one of claims 1 to 4, characterized in that the communication control unit (23) is chosen from among the following means: logic gates with three states, electromechanical relays, static relays.

6. Automatic control facility comprising a transmission bus (22) and a plurality of modules (10) capable of connecting to the transmission bus (22), characterized in that it comprises at least one communication control device according to one of the preceding claims.

7. Automatic control facility according to claim 6, comprising a mechanical system for inserting and extracting the module (10) by rotation about an axis, characterized in that the said control input (25) is linked to a point of the connection element (21) situated in proximity to an opposite end of the connection element from the said rotation axis.
